(19) United States
(12) Patent Application Publication
(10) Pub. No.: US 2011/0098171 A1
(43) Pub. Date: Apr. 28, 2011

(54) METHOD OF PRODUCING GLASS

(75) Inventors: Philippe Pedeboscq, Mareil Marly (FR); Dorothee Martin, Winchester, MA (US); Octavio Cintora, Taverny (FR); Raphael Huchet, Villetaneuse (FR)

(73) Assignee: SAINT-GOBAIN GLASS FRANCE, Courbevoie (FR)

(21) Appl. No.: 12/920,397

(22) PCT Filed: Mar. 3, 2009
(86) PCT No.: PCT/FR09/50344

§ 371 Date: Jan. 5, 2011

(30) Foreign Application Priority Data
Mar. 3, 2008 (FR) 0851371
Sep. 19, 2008 (FR) 0856322

(51) Int. Cl. C03C 14/00; C03B 5/225; C03B 5/16; C03C 3/00

(52) U.S. Cl. 501/32; 65/134.4; 501/11

(57) ABSTRACT

The subject of the invention is a continuous process for preparing glass comprising the successive steps of charging of pulverulent batch materials, and of obtaining a glass bath by melting, of refining then of cooling. The process is characterized in that an oxidizing gas is bubbled within said glass bath after the refining step.

The invention relates to the field of melting glass. It relates more particularly to a process that makes it possible to control the redox level of the glass, and to the products obtained by this process.

The melting of the glass is generally carried out using a continuous process involving a furnace. Introduced at the upstream end of the furnace are pulverulent batch materials (such as, for example, sand, limestone, dolomite, sodium carbonate, boric acid, alumina, feldspars, spodumene, etc.). These not yet molten materials form a blanket that extends over the glass bath in a zone located upstream of the furnace. Specifically the pulverulent batch materials are less dense than the molten glass and float on the latter. The furnace is generally heated using at least one overhead burner, the or each flame of which extends above this zone and also above zones located further downstream and that are not covered by this blanket of non-molten materials. The furnace may, for example, comprise several overhead burners, each developing a flame in a direction substantially perpendicular to the displacement of the glass. Under the effect of the radiation emitted by the or each flame of the at least one burner, the pulverulent materials melt and/or react chemically with one another so as to create a molten glass bath.

This glass bath is, however, filled with gaseous inclusions (or bubbles), since the chemical reactions undergone by the pulverulent batch materials release, in some cases, large amounts of gas (for example, CO₂ for the decarbonation of the limestone or of the sodium carbonate). The glass must be stripped of these gaseous inclusions during a step known as a refining step. This step generally takes place at a temperature higher than the melting step, since the high temperatures have the effect of reducing the viscosity of the glass, thus accelerating the rise of the bubbles in the glass bath and their elimination at the surface of said glass bath. The rise of the bubbles is even faster when the bubbles have a large diameter. One refining technique currently employed consists then in enabling a gas evolution within the glass bath: the bubbles thus formed will coalesce with the residual bubbles of the glass bath, forming bubbles of large diameter, the elimination rate of which is high. This gas evolution is often obtained during refining by the thermally-assisted reduction of initially oxidized species, for example species such as Sb₂O₅, As₂O₅, CeO₂ or SnO₂. These species, known as refining agents, are introduced in small amounts with the other batch materials. To fully play their part in releasing oxygen, it is important that these species are initially very predominantly present in their highest degree of oxidation. In order to do this, it is known to introduce these agents together with oxidizing chemical agents such as nitrates.

Once the glass has been refined, that is to say stripped of its gaseous inclusions, it is then gradually cooled to temperatures where its viscosity makes its processing or forming possible. Schematically, a continuous process for preparing glass comprises the following successive steps, corresponding to different zones of the furnace: charging, melting, then refining and finally cooling (or cooling down).

It is known to bubble oxidizing gases (especially oxygen) into the glass bath during the step of melting or refining the glass, or even close to the charging zone. The objective of this bubbling is generally to oxidize the organic impurities which may be mixed with the batch materials (as described in Application EP-A-0 261 725), or to keep refining agents such as those mentioned above in a high degree of oxidation. The Applications or Patents US 2007/0022780 and U.S. Pat. No. 6,871,514 describe, for example, processes in which a bubbling of oxygen carried out during the charging or melting (at a temperature lower than the refining temperature) makes it possible to stabilize the refining agents in their highest degree of oxidation, thus favoring subsequent refining. Application FR 2 187 709 itself describes the bubbling of oxygen during the melting or refining step in order to homogenize the molten glass. Application US 2008/0034799 lastly describes the bubbling of oxygen during the melting and the refining of special glasses (glasses containing high contents of oxides of heavy metals such as tantalum, lead or bismuth) in order to avoid the reduction of these oxides to metals.

The inventors have now demonstrated that a bubbling of an oxidizing gas carried out after the refining step was able to exhibit certain advantages, especially in terms of redox of the glass formed. These advantages are explained in the remainder of the text. The process according to the invention has proved particularly advantageous for obtaining glasses having a very low redox, therefore very oxidized glasses, without the use of chemical oxidizing agents.

One subject of the invention is therefore a continuous process for preparing glass comprising the successive steps of charging of pulverulent batch materials, and of obtaining a glass bath by melting, of refining then of cooling. The process is characterized in that an oxidizing gas is bubbled within said glass bath after the refining step.

The term “melting” is understood to mean any reaction or set of chemical reactions that make it possible to obtain a mass of molten glass from batch materials in the solid state. It is not generally a melting in the physical sense of the term, even though actual melting reactions may take place in the overall melting process.

The expression “refining step” is understood to mean any step during which the gaseous inclusions contained in the glass bath are eliminated. It may especially be a chemical refining, in the sense where refining agents are introduced with the batch materials. These refining agents are the source of gas evolutions during the melting and refining steps. The refining agents may especially be chosen from arsenic oxides, antimony oxides, cerium oxides or tin oxides, sulfates (especially sodium sulfate or else calcium sulfate, known as gypsum), sulfides (for example zinc sulfide), or else halogens, especially chlorides (for example calcium or barium chloride), or a mixture thereof. Possible mixtures are, for example, tin oxide and/or antimony oxide and halogens such as chlorides. Another possible mixture is the combination between sulfates and reduced species, such as coke or sulfides.

The glass is preferably a silica-based glass, that is to say that contains more than 50%, especially 60%, by weight of SiO₂. It preferably contains less than 1%, or even less than 0.5% or a zero amount of oxides of heavy metals such as Ta, Bi, Pb, Nb, Sb.

According to the invention, the bubbling of oxidizing gas is carried out either between the refining and cooling steps, or during the cooling step. A bubbling at the time of cooling is preferred in certain cases since it has been observed that the lower temperatures favored the more oxidized species. In any case, it is important that the bubbling takes place in a well refined glass bath, that is to say that is substantially free of gaseous inclusions before bubbling. The temperature of the glass bath at the time of the bubbling may be either equal or close to the refining temperature, or, more generally, below this refining temperature.

Preferably, the bubbling of oxidizing gas is only carried out after the refining step. In this case, no bubbling of oxidizing gas is carried out during the melting or refining of the glass, since this type of bubbling has proved not very effective for obtaining the advantages linked to the invention.

The oxidizing gas preferably contains oxygen. It may be, in particular, pure oxygen, or a mixture of oxygen with another gas, especially a neutral gas such as nitrogen or argon. The oxidizing gas preferably does not contain carbon, such as carbon dioxide (CO₂) or hydrocarbons. Pure oxygen is preferred since its oxidizing power is much more effective. Oxygen comprising water vapor can also be used, since it has been proved that water increases the diffusion kinetics of the oxygen in the glass.

It is preferable that the bubbling creates, within the glass bath, bubbles having an average diameter between 0.05 and 5 cm, especially between 0.5 and 5 cm, or even between 1 and 2 cm. This is because bubbles having too small a diameter risk remaining trapped in the glass due to their low rise velocity. Specifically, the bubbling carried out downstream of the process has, with respect to the refining quality, the following two potential risks: a temperature that is generally lower than the refining temperature and a reduced residence time before the forming operation. It is therefore important that the bubbles obtained are relatively large in order to be able to be completely eliminated before the forming operation. Bubbles having too large a diameter have however the drawback of limiting the physicochemical exchanges between the gas and the glass bath, and consequently of limiting the oxidation efficiency of the glass. A large and/or too sudden drop in the temperatures of the glass bath may also be caused by bubbles that have too large a diameter. The bubble size may be adapted by playing with various factors, among which are the gas flow rate and the viscosity of the glass. If the presence of bubbles in the final glass is undesirable, it is possible to carry out a second refining step after bubbling. Generally, this second refining step will not require reheating of the glass or addition of refining agents, but only a reduction in the depth of the glass and/or in the residence time in order to eliminate the bubbles naturally. For certain applications, however, especially applications in the field of photovoltaics or of solar mirrors, it has been revealed that a small number of bubbles could be present in the final glass without in any way impairing the properties of the glass.

The amount of oxidizing gas bubbled within the glass bath is preferably such that the total amount of oxygen (O₂) introduced into said glass bath is between 0.01 and 20 liters per kilogram of glass. This amount is preferably between 0.1 and 10 liters per kilogram of glass, especially between 0.1 and 5 liters per kilogram of glass. The total amount of oxygen introduced will depend on the oxygen composition of the oxidizing gas, on the total flow rate of oxidizing gas, on the residence time of the glass in the furnace, on the amount of glass, on the temperature, on the chemical composition of the glass, etc. For a glass of soda-lime-silica type as described subsequently, the amount of oxygen introduced is preferably between 0.1 and 1 liter per kilogram of glass, especially between 0.2 and 0.9 liters per kilogram of glass. For a precursor glass of a glass-ceramic of lithium aluminosilicate type, explained in the remainder of the text, the amount of oxygen introduced during bubbling is preferably between 0.5 and 2 liters per kilogram of glass. Throughout the text the expression “liter” should be understood to mean “normal liter”.

The temperature of the glass during bubbling has two contradictory effects. From a thermodynamic point of view, it has been shown that the lowest temperatures were capable of promoting the production of oxidized species in the glass. Low temperatures are however accompanied by oxidation reaction kinetics that are slow. Moreover, the rise velocity of the bubbles at low temperature is very slow, which brings about the risk of leaving bubbles trapped at the time of the forming operation. For a desired final degree of oxidation, there is consequently an optimum in terms of temperature which depends on the viscosity of the glass and therefore on its chemical composition. The viscosity of the glass during bubbling is preferably between 100 and 1000 poise (1 poise=1 dPa·s), preferably between 300 and 600 poise, which corresponds to different temperature ranges depending on the nature of the glass. For a glass of soda-lime-silica type as described subsequently, the temperature of the glass during bubbling is preferably between 1200 and 1450° C., especially between 1200 and 1300° C. or between 1300° C. and 1450° C. For a precursor glass of a glass-ceramic of lithium aluminosilicate type, explained in the remainder of the text, the temperature of the glass during bubbling is preferably between 1550 and 1650° C.

Different means for bubbling an oxidizing gas may be used in the context of the process according to the invention.

One preferred embodiment consists in bubbling the oxidizing gas by means of at least one metallic part (plates, tubes, etc.) pierced with a plurality of holes. The part is preferably in the form of a tube inside which the oxidizing gas is injected. The perforated part is preferably located at the end of said tube. The metal is preferably based on platinum, since this metal has a very high melting point and a relative chemical inertness in contact with the molten glass, and withstands oxidation. It may be made of pure platinum, or of platinum alloys, especially of alloys of platinum and rhodium. A platinum alloy containing between 5 and 25% of rhodium has a better mechanical strength than pure platinum but withstands oxidation less well. Doped platinum, especially platinum stabilized with zirconia is preferred. The metal may also have a lower melting point than that of the platinum: it may, for example, be a steel, especially a refractory steel, which will in this case preferably be cooled, especially by circulation of water. Considering their influence on the size of the bubbles, it is preferable that the size of the holes is between 10 and 500 micrometers, especially between 50 and 200 micrometers or between 10 and 150 micrometers, or even between 30 and 60 micrometers. It is preferable that the distance between the holes is greater than or equal to the thickness of the tube in order not to risk embrittling the tube. The production of holes of such small size in the metal tube is preferably carried out using a laser beam or mechanical means (for example using a drill).

Another embodiment consists in bubbling the oxidizing gas by means of at least one porous refractory ceramic part. The part is preferably in the form of a tube inside which the oxidizing gas is injected. The porous ceramic may be, for example, a ceramic foam. Ceramics based on chromium oxide (Cr₂O₃) are preferred due to the fact of the good resistance of this oxide in contact with the glass. Other advantages of the chromium oxide are explained in the remainder of the text. Other ceramics such as zirconia or alumina can also be used. Zirconia is particularly advantageous since it has been observed that zirconia refractories submerged in the glass bath were capable of releasing large amounts of oxygen.

The method of injecting the oxidizing gas may either be continuous, or in pulsed mode. The pulsed mode consists in injecting the gas, for example into the tubes described above, via successive pulses of gas under high pressure with a controlled characteristic pulse time and a controlled period. The pressure preferably varies from 0.5 to 5 bar. The impulse time preferably varies from 10 to 500 ms and the frequency preferably from 0.05 to 2 Hz. At the end of each pulse, the pressure in the tube is instantaneously lowered to the hydrostatic pressure of the tube. With this technique, at each pulse, a single bubble is formed at each hole, which bubble is detached from the tube between two successive pulses due to the pressure drop.

This technique makes it possible to control the size of the bubbles (and especially to obtain smaller bubbles) and also to ensure the bubbling through all the holes.

Another embodiment consists in creating bubbles of oxygen via electrochemical or electrolysis reactions. An electrode (anode) is submerged in the glass, and a potential difference of a few volts is established between this anode and a counter-electrode (cathode). A direct current flows between the anode and the cathode, which generates two types of reactions: bubbles of oxygen are created in contact with the anode, and a reduction of the glass takes place in contact with the cathode. The reduction reactions are various; it may in particular be a reduction of metal ions to metals, for example ferric or ferrous ions to iron metal or even silicon ions to silicon metal. The cathode is therefore preferably positioned at a location of the furnace such as a drain, so as to be able to discharge the glass polluted by these metals. The cathode is preferably made of molybdenum, which withstands the high temperatures and the reduction reactions. The anode is preferably made of platinum, optionally alloyed, for example with rhodium. It is advantageously placed in the furnace so as to maximize the contact with the molten glass. It may, for example, be in the form of a plate positioned transversely to the flow direction of the glass. The distance between the anode and the cathode must not be too large so as not to prevent ionic conduction within the molten glass. The potential difference between the anode and the cathode is preferably between 1 and 10 V, especially between 2 and 5V. The current density is regulated so as to generate the desired amount of bubbles. It is generally between 2 and 10 mA/cm².

The preparation process according to the invention is generally carried out in a melting furnace. The melting furnace is commonly composed of refractories, in general of ceramics such as the oxides of silicon, of aluminum, of zirconium, of chromium, or solid solutions of oxides of aluminum, of zirconium and of silicon. Chromium oxide has proved particularly advantageous since, in combination with the bubbling of oxidizing gas, its presence makes it possible to further reduce the redox of the glass. It would appear that the bubbling of oxidizing gas, in the presence of chromium oxide, generates within the glass and/or at the surface of the refractory, oxidized species of the chromium, which will in turn oxidize the ferrous ions contained in the glass bath. It is therefore preferable that the refractory parts made of chromium oxide are positioned in the vicinity of the zone where the bubbling takes place. These parts may be refractories that constitute the furnace or a part of the latter. Alternatively or cumulatively, they may be parts that are specially added for the implementation of the process according to the invention.

The furnace generally comprises a crown supported by breast walls that form the side walls of the furnace, upstream and downstream end walls and a floor. In a continuous melting process, it is possible to distinguish the downstream of the furnace, which corresponds to the charging zone of the batch materials, then the zones further downstream: the melting zone in which the batch materials are converted to molten glass, then the refining zone, in which the molten glass bath is rid of any gaseous inclusion, then the cooling zone, known as a cooling-down chamber, in which the glass is gradually cooled to the forming temperature, and finally the thermal conditioning zone, where the glass is maintained at its forming temperature, before the forming zone. The forming zone is not an integral part of the furnace. In some cases, the cooling or the thermal-conditioning zone is also located outside of the furnace, generally in channels or “feeders” that bring the molten glass to the forming zone.

The furnace may be of the electric type, that is to say may be heated using electrodes, generally made of molybdenum, submerged in the glass bath. The furnace is however preferably heated using burners. The furnace preferably comprises several overhead burners positioned on the side walls of the furnace, each of said burners being capable of developing a flame transversely to the axis of the furnace. The expression “overhead burner” is understood to mean a burner that develops a flame located above the molten glass bath, and capable of heating this glass bath by radiation. It is also possible for the furnace to contain other types of burners, especially burners capable of heating the glass bath by conduction, for example burners located in the crown or in the end wall, the flame of which impacts the glass bath, or else submerged burners, in the sense where the flame develops within the glass bath.

The overhead burners are preferably positioned regularly from the upstream to the downstream of the furnace and/or are arranged in pairs of burners that face each other or that are in staggered rows, the burners of each pair operating alternately so that, at a given instant, only the burners positioned on one of the side walls develop a flame.

This type of furnace is sometimes known as a “cross-fired furnace”. The alternation in the operating of the pairs of burners makes it possible to use regenerators, through which the combustion gases and the oxidizer are obliged to pass. Composed of stacks of refractory parts, the regenerators make it possible to store the heat emitted by the combustion gases and to release this heat to the oxidizing gas. In a first phase of the alternation, the regenerators located at the burners that are not operating (these burners are positioned on a first wall) store the energy emitted by the flames developed by the burners located on a second wall, which faces the first wall. In a second phase of the alternation, the burners placed on the second wall shut down, whilst the burners placed on the first wall start to operate. The combustion gas (in this case, generally air), which passes into regenerators, is then preheated, which makes substantial energy savings possible.

The furnace preferably comprises, from upstream to downstream, a first tank that delimits the glass-melting zone then the refining zone, then a second tank that delimits a zone for cooling or homogenization of the molten glass. When the second tank delimits a cooling zone, it is preferred that all the burners are positioned in the first tank. In general, a transition zone, known as a neck that is in the form of a tank having a narrower cross section, separates the two tanks described above. It is also possible for the two tanks to be separated by a wall made of refractories that plunges into the glass bath from the crown, making a straight throat, where the glass is forced to pass in order to go from the first to the second tank. The zone of the second tank located immediately after the throat is commonly known as “resurgence”. The furnace may also comprise a third zone that acts as a second refining step. In this zone, the depth of the glass bath is low in order to facilitate the elimination of the bubbles by natural ascent.

The or each bubbling means is positioned in the furnace in a zone in which the refined glass is cooled or is ready to be cooled. In the case of the two-tank furnaces that have just been described, the or each bubbling means is therefore preferably positioned in this second tank, or where appropriate, in the neck, the throat or the resurgence. The bubbling means may, for example, be in the form of a plurality of plates or tubes positioned perpendicular to the flow direction of the glass.

In certain furnaces, convection currents are created due to the existence of hot spots (in particular in the refining zone). These convection currents, which may be accentuated by the choice of the geometry of the furnace, help to obtain a homogeneous glass. Considering these convection currents, one portion of the glass which is refined is returned to the melting zone, whilst the other portion is conveyed to the forming zone. In the case, for example, of furnaces where the surface glass is drawn off with a view to the forming, the portion of the glass beneath the surface is returned to the hot spot. Since the high temperatures have a tendency to favor reduced species, it is not preferable to bubble the oxidizing gas in this part of the glass bath. It is, on the other hand, preferable to bubble the oxidizing gas in the portion of the glass which is conveyed to the forming zone, therefore close to the surface of the glass.

For a glass that contains iron oxide, the oxidation of the glass may be characterized by the “redox”, which is a number equal to the ratio of the content of ferrous iron (expressed as weight percentage of FeO) to the content of total iron in the glass (expressed as weight percentage of Fe₂O₃). The content of ferrous iron is determined by chemical analysis: the determination using the optical spectrum, common for glasses containing at least 0.02% of FeO, is here completely unsuitable and leads to the true content of FeO in the glass being greatly underestimated.

According to one preferred embodiment, the glass obtained has a redox less than or equal to 0.1, especially 0.08 and even 0.05 or 0.03. The redox may even be equal to 0. Redox values of zero may be obtained, in particular but not only, by using parts made of chromium oxide in contact with the glass bath.

The process according to the invention has indeed proved particularly advantageous for obtaining glasses having a very low redox. These glasses could until now only be obtained by a chemical route, in this case by addition of oxidizing agents such as As₂O₅, Sb₂O₅ or CeO₂. These oxidizing agents (which are also refining agents) are not however free from drawbacks. Thus, arsenic and antimony oxides, besides their toxicity, are not compatible with the float glass process, which consists in forming a sheet of glass by pouring molten glass onto a bath of molten tin. Cerium oxide itself leads to risks of solarization, that is to say of modification of the optical properties of the glass under the effect of ultraviolet radiation.

The inventors have demonstrated that there was an optimum temperature of the glass during the bubbling as a function of the targeted redox.

Thus, for a redox of around 0.1 and a glass of soda-lime-silica type, the temperature of the glass during the bubbling is preferably between 1350° C. and 1450° C. For a redox of around 0.06, the temperature of the glass during the bubbling is preferably between 1250° C. and 1350° C. For a redox of less than 0.05, the temperature of the glass during the bubbling is preferably between 1150° C. and 1250° C. For a glass of soda-lime-silica type, one particularly preferred temperature range is between 1200 and 1350° C., in particular between 1200 and 1300° C. or between 1250 and 1350° C., or even between 1280° C. and 1330° C. In a continuous melting furnace, redox values of zero have been able to be obtained for bubbling temperatures between 1300 and 1350° C., in particular of around 1320° C.

The glass obtained is preferably characterized by an iron oxide content of less than or equal to 0.15% and especially a redox less than or equal to 0.1, especially 0.08 and even 0.05 or 0.03.

The process according to the invention is therefore particularly beneficial for the preparation of glass substrates intended for photovoltaic cells, solar cells, flat or parabolic mirrors for concentrating solar power, or else diffusers for backlighting display screens of the LCD (liquid crystal display) type. For all these applications, it is indeed important that the glass substrate has the highest optical transmission possible in the visible and near infrared ranges. This property makes it necessary to reduce, as much as possible, the amount of ferrous iron (FeO) in the glass, consequently to reduce, as much as possible, the total amount of iron oxide (through the choice of particularly pure batch materials) and the redox of the glass.

The glass obtained therefore preferably contains a total iron oxide content of less than or equal to 0.08% by weight, preferably 0.02%, and especially 0.01% or 0.009% and a redox less than or equal to 0.1, especially 0.08 and even 0.05.

Alternatively, the glass obtained may contain an iron oxide content between 0.08% and 0.15% and a redox in the aforementioned range. This iron oxide range corresponds to the content of iron oxide typically obtained from common batch materials. The invention makes it possible, in this case, to obtain redox values and optical transmissions that are as high as those obtained until now by glasses that are iron-oxide-depleted, produced from batch materials (especially sands) that are iron-depleted and that are consequently more expensive.

The chemical composition of these glasses may especially be of the soda-lime-silica type, or else of the borosilicate type. The compositions of soda-lime-silica type lend themselves better to forming via the float process and are consequently preferred.

The expression “soda-lime-silica glass” is understood to mean a glass having a composition comprising, in percentages by weight:

| | |
|---|---|
| SiO₂ | 60-75% |
| B₂O₃ | 0-5% |
| Al₂O₃ | 0-10% |
| MgO | 0-8% |
| CaO | 6-15% |
| Na₂O | 10-20% |
| K₂O | 0-10% |

The K₂O content is preferably greater than or equal to 1.5%, as taught in Application FR-A-2 921 357, since this makes it possible to increase the energy transmission of the glass even more, and this facilitates the oxidation of the glass. Preferably, the K₂O content is greater than or equal to 2%, especially 3%.

A product that is capable of being obtained for the first time owing to the invention is a substrate made of glass, especially of the soda-lime-silica type, the composition of which is free of arsenic oxides, antimony oxides and cerium oxides, said composition comprising a total iron oxide content of less than or equal to 0.2% and redox less than or equal to 0.1, especially 0.08 and even 0.05 or else 0.03, or even zero.

According to a first preferred embodiment, the iron oxide content is less than or equal to 0.02% by weight, especially 0.01% and even 0.009%. These substrates make it possible to obtain optical transmissions that are at least as good as those obtained currently via the use of chemical oxidizing agents such as antimony oxide.

According to a second preferred embodiment, the iron oxide content is greater than 0.02%, especially between 0.05% and 0.15% by weight. These substrates make it possible to obtain optical transmissions that are equivalent to those currently obtained by glasses that are depleted in iron oxide (0.015% or less) and that do not contain chemical oxidizing agents.

The glass substrate according to the invention may also contain bubbles of oxygen, in particular bubbles having a diameter that does not exceed 200 micrometers. Preferably, at least 95% of the bubbles, or even all of the bubbles, have a diameter of less than 200 micrometers. The amount of bubbles may advantageously be between 500 and 10 000 bubbles per liter of glass, especially between 500 and 6000 bubbles per liter of glass. As indicated previously, it has been shown that the presence of oxygen bubbles did not have any drawback for certain targeted applications hereinbelow.

The soda-lime-silica glass composition may comprise, besides the inevitable impurities contained, in particular in the batch materials, a low proportion (up to 1%) of other constituents, for example agents that aid the melting or refining of the glass (SO₃, Cl, etc.), or else of elements originating from the dissolution of the refractories used to construct the furnaces (for example, ZrO₂).

The composition according to the invention preferably does not comprise any agent that absorbs visible or infrared radiation (especially for a wavelength between 380 and 1000 nm) other than those already mentioned. In particular, the composition according to the invention preferably does not contain agents chosen from the following agents: oxides of transition elements such as CoO, CuO, Cr₂O₃, MnO₂, oxides of rare earths such as Er₂O₃, CeO₂, La₂O₃, Nd₂O₃, or else coloring agents in the elemental state such as Se, Ag, Cu. These agents very often have a very powerful undesirable coloring effect, that is manifested at very low contents, sometimes of the order of a few ppm or less (1 ppm=0.0001%). Their presence thus very strongly reduces the transmission of the glass. The WO₃ content is generally less than 0.1%.

The glass substrates according to the invention are in the form of glass sheets. The substrate is preferably of the floated type, that is to say capable of having been obtained by a process that consists in pouring the molten glass onto a bath of molten tin. It may also be obtained by rolling between two rolls, a technique that makes it possible, in particular, to print motifs on the surface of the glass. Certain motifs may be advantageous, as explained below.

This substrate may, in particular, be used in photovoltaic cells, solar cells, flat or parabolic mirrors for concentrating solar power, or else diffusers for backlighting display screens of the LCD (liquid crystal display) type. It may also be used for interior applications (partitions, furniture, etc.) or in electrical goods (refrigerator shelves, etc.).

In the case of applications in the field of photovoltaics, and in order to maximize the energy efficiency of the cell, several improvements may be made, cumulatively or alternately:
the substrate may advantageously be coated with at least one thin transparent and electro-conductive layer, for example based on SnO₂:F, SnO₂:Sb, ZnO:Al, ZnO:Ga. These layers may be deposited onto the substrate by various deposition processes, such as chemical vapor deposition (CVD) or deposition by sputtering, especially when enhanced by a magnetic field (magnetron sputtering process). In the CVD process, halide or organometallic precursors are vaporized and transported by a carrier gas to the surface of the hot glass, where they decompose under the effect of the heat to form the thin layer. The advantage of the CVD process is that it is possible to use it within the process for forming the glass sheet, especially when it is a float process. It is thus possible to deposit the layer at the moment when the glass sheet is on the tin bath, at the outlet of the tin bath, or else in the lehr, that is to say at the moment when the glass sheet is annealed in order to eliminate the mechanical stresses. The glass sheet coated with a transparent and electroconductive layer may be, in turn, coated with a semiconductor based on amorphous or polycrystalline silicon or on CdTe in order to form a photovoltaic cell. It may especially be a second thin layer based on amorphous silicon or on CdTe. In this case, another advantage of the CVD process lies in obtaining a greater roughness, which generates a light-trapping phenomenon, which increases the amount of photons absorbed by the semiconductor.
the substrate may be coated on at least one of its faces with an antireflection coating. This coating may comprise a layer (for example based on porous silica having a low refractive index) or several layers: in the latter case a stack of layers based on a dielectric material that alternates between layers having low and high refractive indices and that terminates with a layer having a low refractive index is preferred. It may especially be a stack described in Application WO 01/94989 or WO 2007/077373. The antireflection coating may also comprise, as the last layer, a self-cleaning and anti-soiling layer based on photocatalytic titanium oxide, as taught in Application WO 2005/110937. It is thus possible to obtain a low reflection that is long-lasting. In applications in the field of photovoltaics, the antireflection coating is positioned on the outer face, that is to say the face in contact with the atmosphere, whilst the optional transparent electroconductive layer is positioned in the inner face, on the side of the semiconductor.
the surface of the substrate may be textured, for example have motifs (especially pyramid-shaped motifs), as described in Applications WO 03/046617, WO 2006/134300, WO 2006/134301 or else WO 2007/015017. These texturings are in general obtained using a rolling process for forming the glass.

The process has also proved particularly advantageous for obtaining precursor glasses for glass-ceramics of the lithium aluminosilicate type that are colorless.

The expression glass or glass-ceramic of the “lithium aluminosilicate” type is understood to mean a glass or a glass-ceramic which comprises the following constituents, within the limits defined below, expressed as percentages by weight:

| | |
|---|---|
| SiO₂ | 52-75% |
| Al₂O₃ | 18-27% |
| Li₂O | 2.5-5.5% |
| K₂O | 0-3% |
| Na₂O | 0-3% |
| ZnO | 0-3.5% |
| MgO | 0-3% |
| CaO | 0-2.5% |
| BaO | 0-3.5% |
| SrO | 0-2% |
| TiO₂ | 1.2-5.5% |
| ZrO₂ | 0-3% |
| P₂O₅ | 0-8% |

This glass or this glass-ceramic may comprise up to 1% by weight of non-essential constituents that do not affect the melting of the glass or the subsequent devitrification that results in the glass-ceramic.

Preferably, the glass or the glass-ceramic of lithium aluminosilicate type comprises the following constituents, within the limits defined below, expressed as percentages by weight:

| | |
|---|---|
| SiO₂ | 65-70% |
| Al₂O₃ | 18-19.8% |
| Li₂O | 2.5-3.8% |
| K₂O | 0-<1.0% |
| Na₂O | 0-<1.0% |
| ZnO | 1.2-2.8% |
| MgO | 0.55-1.5% |
| BaO | 0-1.4% |
| SrO | 0-1.4% |
| TiO₂ | 1.8-3.2% |
| ZrO₂ | 1.0-2.5% |

These glass-ceramics, due to their almost zero thermal expansion coefficients, are extremely resistant to heat shocks. Therefore, they are frequently used as hobs, especially hobs that cover heating elements, or chimney inserts.

These glass-ceramics are obtained by a two-step process: in a first step, plates of precursor glass are obtained, which undergo, in a second step, a controlled crystallization treatment.

This heat treatment, called “ceramization”, makes it possible to grow, within the glass, crystals of β-quartz or β-spodumene structure (depending on the ceramization temperature), which have the distinctive feature of possessing negative thermal expansion coefficients.

The precursor glass may, for example, undergo a ceramization cycle comprising the following steps:
a) the temperature is raised to the nucleation range, generally lying close to the conversion range, especially at 50-80° C. per minute;
b) the temperature passes through the nucleation range (670-800° C.) over around 20 minutes;
c) the temperature is raised to the temperature T of the ceramization plateau between 900 and 1000° C. over 15 to 30 minutes;
d) the temperature T of the ceramization plateau is maintained for a time t of 10 to 25 minutes; and
e) the glass is rapidly cooled down to ambient temperature.

The presence, in the final glass-ceramic, of such crystals and of a residual glassy phase, makes it possible to obtain a thermal expansion coefficient that is in the main zero or very low (the absolute value of the expansion coefficient is typically less than or equal to 15×10⁻⁷/° C., or even 5×10⁻⁷/° C.). The size of the crystals of β-quartz structure is generally very small so as not to diffuse the visible light. The glass-ceramics thus obtained are therefore transparent, and may have a coloration if coloring agents are added during the melting. The crystals of β-spodumene structure are obtained by treatments at higher temperature, and generally have larger sizes. They may diffuse the visible light, giving rise to translucent, but not transparent glass-ceramics. The glass is conventionally refined using refining agents such as Sb₂O₅ or As₂O₅, the drawbacks of which have already been mentioned.

More recently, more effective alternative chemical refining agents have been proposed, which are metal sulfides. The metal sulfides make it possible to obtain a very good refining quality and are compatible with the float process. These metal sulfides, in combination with the other elements of the glass, confer however a blue coloration to the glass obtained and to the glass-ceramic derived from the precursor glass. This drawback does not exist in the case of tinted glass-ceramics, such as the dark red glass-ceramics obtained by coloring with vanadium oxide. In the case of colorless glass-ceramics, whether they are translucent or transparent, the use of sulfides as refining agents has, on the contrary, proved unsuitable.

The process according to the invention makes it possible to solve this problem. The inventors have in effect discovered that the undesirable blue coloration was linked to the reduction, during the melting step, of the Ti⁴⁺ ion to the Ti³⁺ ion by the sulfides. The process according to the invention makes it possible, after the refining step, to restore the lack of color by reoxidation of the titanium ion.

According to one preferred embodiment of the process according to the invention, the glass is a precursor glass for a glass-ceramic of the lithium aluminosilicate type that is colorless, and at least one reducing agent is added to the batch materials.

The expression “precursor glass” is understood to mean any glass capable of forming a glass-ceramic after adequate ceramization treatment.

The reducing agent is preferably chosen from a carbon-based reducing agent such as coke, or metal sulfides. The coke disappears during the melting by converting to gaseous CO₂.

The metal sulfide is preferably chosen from transition metal sulfides, for example zinc sulfide, alkali metal sulfides, for example potassium sulfide, sodium sulfide and lithium sulfide, alkaline-earth metal sulfides, for example calcium sulfide, barium sulfide, magnesium sulfide and strontium sulfide. The preferred sulfides are zinc sulfide, lithium sulfide, barium sulfide, magnesium sulfide and strontium sulfide. Zinc sulfide has proved particularly advantageous since it does not contribute to coloring the glass or the glass-ceramic. It is also favored when the glass-ceramic must contain zinc oxide: in this case the zinc sulfide plays a double role of a reducing/refining agent and as a source of zinc oxide.

The sulfide may also be introduced into the glass batch materials in the form of a slag or sulfide-enriched glass frit which has the advantage of accelerating the digestion of the batch stones, or improving the chemical homogeneity of the glass and its optical quality. However, it is well known that the slags also contain iron in a significant amount which reduces the transmission of infrared rays. From this point of view, it is preferable to use glass frits whose chemical composition, especially its iron content, can be perfectly controlled.

Preferably, the sulfide is added to the glass batch materials in an amount of less than 2%, advantageously less than 1% and better still between 0.07 and 0.8% of the total weight of the glass batch materials. In the case of coke, the content introduced is preferably between 800 and 1500 ppm (1 ppm=0.0001% by weight).

To fulfill its role as a refining agent, the reducing agent is combined with an oxidizing agent, preferably a sulfate. Sulfates have the advantage of not forming coloring species in the glass or the glass-ceramic. Tin oxide on the other hand, gives a yellow coloration, and cannot therefore be used as an oxidizing agent. The sulfate may especially be a sodium, lithium or else magnesium sulfate.

The sulfate contents introduced are preferably between 0.2 and 1% by weight, especially between 0.4 and 0.8%, expressed as SO₃. In order to obtain an optimum refining quality, it is advisable to introduce enough reducing agent relative to the amount of oxidizing agent. In the case where the reducing agent is a sulfide and the oxidizing agent is a sulfate, it is preferred that the amount by weight of sulfur provided by the sulfide represents more than 60%, or even 70% of the total sulfur introduced. In the case where the reducing agent is coke, it is preferred that the coke/sulfate ratio introduced is greater than or equal to 0.15, especially 0.18 and even 0.20. In this way, a refining of excellent quality and also a rapid melting is ensured.

Preferably, the melting point of the batch materials is less than or equal to 1700° C., and advantageously greater than 1600° C.

The temperature of the precursor glass during the bubbling is preferably between 1550° C. and 1650° C.

Another subject of the invention is a colorless glass or glass-ceramic substrate of the lithium aluminosilicate type. This subject is characterized in that it is free of arsenic oxide, antimony oxide, cerium oxide and tin oxide, and in that it contains less than 1 bubble per cm³. The amount of bubbles is preferably less than or equal to 10⁻², or even 10⁻³ bubbles/cm³. It preferably contains sulfur in an analyzable amount, especially in a weight content between 10 and 500 ppm of SO₃, or even between 10 and 100 ppm of SO₃.

Such glasses or glass-ceramics that are colorless and nevertheless well refined could be obtained previously only by the use of refining agents such as arsenic or antimony oxides. The invention makes it possible, for the first time, to result in colorless glass-ceramics that are free of such agents and yet that are correctly refined, in the sense that they do not contain gaseous inclusions. It is of course possible to obtain, on the laboratory scale, glass-ceramics that are colorless and free of any refining agent, but the absence of refining agents inevitably generates a large amount of bubbles.

The glass-ceramics according to the invention are preferably transparent and generally contain in this case crystals which are solid solutions of the β-quartz type. The term “colorless” is understood to mean the substantial absence of color visible to the naked eye. A material totally devoid of color is obviously impossible to obtain, and it is possible to express this absence of color by the fact that the colorimetric coordinates a* and b* are both between −10 and +10, in particular between −2 and +6, for a thickness of 3 mm. Preferably, the a* coordinate is between −2 and +1, and/or the b* coordinate is between 0 and +6, in particular between 0 and +5. A very positive a* coordinate corresponds to a red color, and very negative one to a green color. A very positive b* coordinate corresponds to a yellow color, and a very negative one to a blue color. The glass-ceramic or the precursor glass according to the invention are preferably transparent (and not only translucent). In this case, it is preferable that the L* coordinate is greater than or equal to 80 or even 90 and even 92, and/or that the light transmission (T_{L}) is greater than or equal to 80%, or even 85%. These parameters are calculated in a known manner, from an experimental spectrum produced for wavelengths between 380 and 780 nm, taking into consideration the illuminant D65 as defined by the ISO/CIE 10526 standard and the C.I.E. 1931 standard colorimetric observer as defined by the ISO/CIE 10527 standard. All the values are given for a glass or glass-ceramic thickness of 3 mm.

The expression “bubble” is understood to mean any type of gaseous inclusion, without prejudging their size or the composition of the gases that they contain.

In order to avoid any undesirable coloration, the glass or the glass-ceramic according to the invention preferably does not contain the following oxides: Fe₂O₃, NiO, Cr₂O₃, CuO, CoO, Mn₃O₄ and V₂O₅, with the exception of the inevitable impurities in sufficiently low contents so as not to affect the desired colorless nature. In particular, it is difficult to avoid the presence of traces of iron oxide (Fe₂O₃), and the iron oxide content is preferably less than or equal to 0.05%, or even 0.02% in order not to confer color on the product obtained.

These substrates may be, in particular, used as hobs, especially hobs that cover heating elements, or chimney inserts. For an application as a hob that covers heating elements, it is preferable to deposit on the lower face (the closest to the heating elements) an opaque layer in order not to be dazzled by the elements.

The invention will be better understood on reading the following non-limiting exemplary embodiments.

### EXAMPLE 1

### Production of a Colorless Glass-Ceramic of the Lithium Aluminosilicate Type

Batch materials are introduced into a furnace heated using burners that operate with oxygen. The glass bath obtained is of the lithium aluminosilicate type: it is a precursor glass intended to be ceramized in order to obtain a glass-ceramic. The batch materials are chosen in order to obtain a glass bath having the following average composition by weight:

| | |
|---|---|
| SiO₂ | 68.6% |
| Al₂O₃ | 19.5% |
| Fe₂O₃ | 0.017% |
| Li₂O | 3.6% |
| ZnO | 1.8% |
| MgO | 1.2% |
| BaO | 0.8% |
| TiO₂ | 2.7% |
| ZrO₂ | 1.7% |

The melting point is around 1600° C. to 1650° C.

The refining is carried out either using arsenic oxide (example C1, in which 0.6% of arsenic oxide is introduced with the batch materials), or (examples C2 and 1 and the following ones) using zinc sulfide (ZnS, equal to 0.12% sulfur, i.e. 0.3% of SO₃) combined with sodium sulfate (equal to 0.13% of SO₃). The sulfide/sulfate ratio introduced is such that the sulfide provides 70% of the total sulfur, which allows a refining of excellent quality.

In a zone of the furnace where the glass is refined, and is therefore free of any gaseous inclusion, oxygen is, where appropriate, bubbled within the glass bath using a tube of platinum-rhodium alloy pierced with a multitude of holes, the diameter of which is 50 micrometers. The size of the bubbles is around 1 cm.

After forming in order to obtain a flat substrate, the latter is ceramized as indicated supra in order to obtain a glass-ceramic.

Table 1 below indicates, for each example, the temperature of the glass during the bubbling (denoted by T, measured by pyrometry, and expressed in ° C.) and the amount of oxygen (denoted by QO₂ and expressed in liters) bubbled per kilogram of glass. It also indicates the following optical properties of the glass-ceramic for a thickness of 3 mm:
the overall light transmission factor (T_{L}), calculated between 380 and 780 mm, taking into consideration the illuminant D65 as defined by the ISO/CIE 10526 standard and the C.I.E. 1931 standard calorimetric reference as defined by the ISO/CIE 10527 standard;
the calorimetric coordinates (L*, a*, b*), calculated between 380 and 780 mm, taking into consideration the illuminant D65 as defined by the ISO/CIE 10526 standard and the C.I.E. 1931 standard calorimetric reference as defined by the ISO/CIE 10527 standard.

TABLE 1

| | | QO₂ | | | | |
|---|---|---|---|---|---|---|
| | T (° C.) | (l/kg) | TL | L* | a* | b* |
| C1 | — | 0 | 88.1 | 95.2 | −0.3 | 3.6 |
| C2 | — | 0 | 1.7 | 13.8 | 7.3 | −27.5 |
| 1 | 1600 | 0.5 | 14.4 | 44.8 | 0 | −18.1 |
| 2 | 1560 | 0.5 | 65.6 | 84.8 | 0 | 2.6 |
| 3 | 1600 | 1 | 82.3 | 92.7 | −0.2 | 4.6 |
| 4 | 1650 | 2 | 88.5 | 95.4 | −1.4 | 6.2 |
| 5 | 1600 | 2 | 89.1 | 95.6 | −0.5 | 3.5 |
| 6 | 1560 | 2 | 82.2 | 92.6 | 0.2 | 3.5 |
| 7 | 1600 | 10 | 88.7 | 95.5 | −0.6 | 3.5 |

The comparative example C1 corresponds to a colorless and transparent glass-ceramic, the precursor glass of which was refined in a conventional manner using arsenic oxide. The precursor glass was not subjected to bubbling according to the invention.

The comparative example C2 corresponds to a glass-ceramic, the precursor glass of which was refined using a mixture of sulfate and sulfide (in this case zinc sulfide). In the absence of bubbling according to the invention, the glass-ceramic obtained has a very pronounced blue tint, characterized by a very negative b* value. The light transmission is very low, so much so that the vision through the glass-ceramic is greatly reduced.

In the examples according to the invention numbered 1 to 7, the precursor glass, refined in the same manner as for example C2, was bubbled using oxygen. For small amounts of oxygen (0.5 liter per kg of glass), a bubbling at 1600° C. makes it possible to obtain a glass-ceramic that is less blue, whilst a bubbling at a slightly lower temperature (1560° C.) makes it possible to obtain a glass-ceramic that is colorless, although less transmissive than the glass-ceramic C1. For larger amounts of oxygen, the glass-ceramic obtained has optical properties similar to those of the conventional glass-ceramic C1. The process according to the invention consequently makes it possible to obtain colorless glass-ceramics without the precursor glass having been refined using arsenic oxide, antimony oxide or tin oxide.

### EXAMPLE 2

### Production of a Glass of the Soda-Lime-Silica Type and Having a Low Redox

Glasses of the soda-lime-silica type containing 100 ppm of iron oxide (expressed in the form of Fe₂O₃) were melted in a fired furnace (batchwise melting in pots).

After refining, therefore when the glass is free of any gaseous inclusion, oxygen is, where appropriate, bubbled within the glass bath using a tube made of platinum-rhodium alloy pierced with a multitude of holes, the diameter of which is 50 micrometers. The size of the bubbles is around 1 cm.

The comparative example C3 is a glass containing antimony oxide Sb₂O₃, the latter acting as a refining agent and oxidizing agent for the iron. It was not bubbled.

In the examples according to the invention, the refining is carried out using sulfate. The glass does not comprise any arsenic oxide, antimony oxide or cerium oxide.

Table 2 below indicates, for each example, the temperature of the glass during the bubbling, the amount of oxygen bubbled (in liters per kg of glass) and the redox of the glass obtained.

TABLE 2

| | QO₂ (l/kg) | T bubbling (° C.) | Redox |
|---|---|---|---|
| C3 | — | — | 0.05 |
| 8 | 0.1 | 1350 | 0.26 |
| 9 | 0.1 | 1250 | 0.39 |
| 10 | 0.3 | 1350 | 0.11 |
| 11 | 0.3 | 1250 | 0.06 |
| 12 | 0.3 | 1150 | 0.36 |
| 13 | 0.6 | 1350 | 0.04 |
| 14 | 0.6 | 1250 | 0.04 |
| 15 | 0.6 | 1150 | 0.27 |
| 16 | 0.9 | 1350 | 0.04 |

The reference example is highly oxidized (redox of 0.05) due to the presence of antimony oxide. The bubbling according to the invention makes it possible, in certain cases, especially for amounts of oxygen introduced that are greater than 0.5 l/kg of glass and bubbling temperatures between 1200 and 1350° C., to obtain even lower redox values. On the other hand, a bubbling carried out before or during the refining does not make it possible to obtain such redox values.

The glass is even more oxidized when the amount of oxygen bubbled is high. For the same amount of oxygen, there is an optimum temperature, since high temperatures tend to favor high redox values whilst at lower temperatures the oxidation kinetics are reduced.

### EXAMPLE 3

Melted in a continuous-melting furnace equipped with a first tank dedicated to the melting and to the refining, with a throat and with a resurgence is a glass of the soda-lime-silica type, which is then floated in order to obtain sheets of glass having a thickness of 2.9 mm. An oxygen-bubbling device formed from a part made of platinum pierced with a multitude of orifices having a diameter of 50 micrometers is submerged in the glass bath at the resurgence, where the temperature of the glass is around 1350 to 1400° C. The oxygen flow rate varies between 2 and 5 Nl/min, forming bubbles of around 1 cm in diameter within the glass bath.

In the case of a glass comprising 0.014% of Fe₂O₃ (total iron), the bubbling makes it possible to very greatly reduce the redox, from around 0.4 before bubbling to a value between 0.05 and 0.1 during bubbling. The introduction of refractory parts made of chromium oxide in the vicinity of the bubbling device even makes it possible to obtain a zero redox. The energy transmission of the glass obtained (according to ISO 9050 standard) is greater than 91.5%.

In the case of a glass containing around 0.04% of iron oxide, the redox obtained, of around 0.11 to 0.14, makes it possible to obtain optical properties that are equivalent to those of a glass containing 0.014% of iron oxide without bubbling.

### EXAMPLE 4

A mass of molten glass is obtained in a continuous melting furnace that is heated using flames and is constructed of refractories of fused-cast alumina-zirconia-silica type. The melting point is around 1380° C. The chemical compositions tested are indicated in table 3 below, expressed as percentages by weight.

TABLE 3

| | A | B |
|---|---|---|
| SiO₂ | 71.8 | 71.8 |
| Al₂O₃ | 0.55 | 0.55 |
| CaO | 9.5 | 8.7 |
| MgO | 4.0 | 4.0 |
| Na₂O | 13.85 | 11.1 |
| K₂O | 0 | 3.5 |
| Fe₂O₃ | 0.01 | 0.01 |

The furnace is provided with a throat and with resurgence and placed in the latter is a row of bubblers made of a platinum-rhodium alloy containing 10% rhodium that are each formed from a tube pierced with a multitude of orifices whose diameter is between and 100 micrometers. The refined glass arrives in the resurgence where the temperature is 1325° C. The oxygen flow rate varies between 0 and 1 Nl/kg of glass, forming within the molten glass bubbles whose diameter is approximately between 1 and 2 cm.

Represented in table 4 below is the redox obtained as a function of the oxygen flow rate. It is possible to see that the redox values may be zero for flow rates of around 0.46 Nl/kg or above.

TABLE 4

| Flow rate (Nl/kg) | Redox |
|---|---|
| 0 | 0.26 |
| 0.23 | 0.12 |
| 0.46 | 0 |
| 0.93 | 0 |

In a second type of test, the oxygen flow rate is zero, but the bubblers are polarized so as to form anodes. A cathode made of molybdenum is placed at a drain so as to complete the electrical circuit. Redox values of almost zero are also achieved by virtue of this technique, for current densities between 2 and 10 mA/cm², typically of 5 mA/cm², and potential differences of around a few volts.

It has been observed that the oxidation is more readily achieved in the case of composition B.

As the present invention is described in the aforegoing by way of example, it is understood that a person skilled in the art is in position to carry out various variants thereof without however departing from the scope of the patent as defined by the claims.

1. A continuous process for preparing glass comprising, successively:
charging pulverulent batch materials into a furnace; and
obtaining a glass bath by melting the pulverulent batch materials;
refining the glass bath; then
cooling the glass bath, wherein an oxidizing gas is bubbled within said glass bath after the refining.

2. The process as claimed in claim 1, wherein the oxidizing gas is bubbled within the glass bath during the cooling.

3. The process as claimed in claim 1, wherein the oxidizing gas is only bubbled within the glass bath after the refining.

4. The process as claimed in claim 1, wherein the oxidizing gas is oxygen.

5. The process as claimed in claim 1, wherein bubbling creates, within the glass bath, bubbles having an average diameter between 0.05 and 5 cm.

6. The process as claimed in claim 1, wherein an amount of oxidizing gas bubbled within the glass bath is such that a total amount of oxygen (O₂) introduced into said glass bath is between 0.01 and 20 liters per kilogram of glass.

7. The process as claimed in claim 1, wherein the oxidizing gas is bubbled by at least one metallic part pierced with a plurality of holes.

8. The process as claimed in claim 1, wherein the oxidizing gas is bubbled by at least one porous refractory ceramic part.

9. The process as claimed in claim 1, wherein a the viscosity of the glass during bubbling is between 100 and 1000 poise.

10. The process as claimed in claim 1, wherein the glass comprises more than 50% by weight of SiO₂.

11. The process as claimed in claim 1, wherein the glass obtained has a redox of less than or equal to 0.1.

12. The process as claimed in claim 11, wherein the glass obtained comprises a total iron oxide content of less than or equal to 0.15% by weight.

13. The process as claimed in claim 1, wherein the glass is a precursor glass for a glass-ceramic of the lithium aluminosilicate type that is colorless, and the batch materials comprise at least one reducing agent and, optionally, sulfate.

14. The process as claimed in claim 13, such that the at least one reducing agent is selected from the group consisting of coke and a metal sulfide.

15. The process as claimed in claim 13, wherein a the temperature of the glass during bubbling is between 1550° C. and 1650° C.

16. A substrate made of glass, a composition of which is devoid of arsenic oxides, antimony oxides and cerium oxides, said composition comprising a total iron oxide content of less than or equal to 0.2% by weight and having a redox of less than or equal to 0.1.

17. The substrate as claimed in claim 16, comprising a total iron oxide content of less than or equal to 0.02% by weight.

18. The substrate as claimed in claim 16, comprising a total iron oxide content which is greater than 0.02% and less than or equal to 0.15%.

19. The substrate as claimed in claim 16, comprising an amount of oxygen bubbles between 500 and 10 000 bubbles per liter of glass.

20. A substrate made of a colorless glass or a lithium aluminosilicate glass-ceramic, which is devoid of arsenic oxide, antimony oxide, cerium oxide, and tin oxide, and comprises less than 1 bubble per cm³.

21. A photovoltaic cell, solar cell, flat or parabolic mirror for concentrating solar power, or diffuser, comprising the substrate of claim 16.

22. A hob comprising the glass-ceramic substrate of claim 16.
